(19) United States
(12) Patent Application Publication
(10) Pub. No.: US 2009/0207104 A1
(43) Pub. Date: Aug. 20, 2009

(54) DEMULTIPLEXER AND ORGANIC LIGHT EMITTING DISPLAY DEVICE USING THE SAME

(76) Inventor: Wang-Jo Lee, Suwon-si (KR)

Correspondence Address: CHRISTIE, PARKER & HALE, LLP, PO BOX 7068, PASADENA, CA, 91109-7068, US

(21) Appl. No.: 12/208,217

(22) Filed: Sep. 10, 2008

(30) Foreign Application Priority Data
Feb. 20, 2008 (KR) 10-2008-0015398

(51) Int. Cl. G09G 3/32

(52) U.S. Cl. 345/76

(57) ABSTRACT

An organic light emitting display device, wherein the device includes a scan driver for supplying a scan signal to scan lines during a frame time-divided into a plurality of subframes, a data driver coupled to output lines for supplying data signals on each of the output lines, demultiplexers coupled to the output lines for supplying the data signals to data lines, and pixels located at crossing regions of the data lines and the scan lines. Each of the demultiplexers includes a switch coupled between a corresponding one of the output lines and a first data line of the data lines, and a second data line of the data lines is directly coupled to the corresponding one of the output lines.

### CROSS-REFERENCE TO RELATED APPLICATION

This application claims priority to and the benefit of Korean Patent Application No. 10-2008-0015398, filed on Feb. 20, 2008, in the Korean Intellectual Property Office, the entire content of which is incorporated herein by reference.

### BACKGROUND OF THE INVENTION

1. Field of the Invention

The present invention relates to a demultiplexer and an organic light emitting display device using the same.

2. Description of Related Art

In recent years, flat panel display devices having reduced weight and volume in comparison to a cathode ray tube (CRT) have been developed. The flat panel display devices include the following displays: a liquid crystal display (LCD), a field emission display (FED), a plasma display panel (PDP), an organic light emitting display, etc.

Among the flat panel displays, the organic light emitting display device displays an image using organic light emitting diodes (OLEDs) to emit light through the recombination of electrons and holes. Such an organic light emitting display device has rapid response time and low power consumption.

Pixels in conventional organic light emitting display devices utilizing an analog drive system display an image by charging a storage capacitor Cst in each of the pixels with a predetermined voltage and supplying an electrical current, which corresponds to the charged voltage, to the organic light emitting diodes. Analog drive systems may have difficulty uniformly displaying an image due to the variations in the threshold voltage and mobility of the drive transistors between the pixels.

Organic light emitting displays utilizing a digital drive system rather than an analog drive system may more uniformly display an image. The digital drive system supplies data signals to each of the pixels, wherein the data signals correspond to turn-on and turn-off states, and displays gray levels by controlling the time that the pixels are turned on during a frame that is time-divided into a plurality of subframes. The digital drive system may display an image uniformly regardless of the variations of the drive transistors between the pixels.

Digital drive systems may have difficulty supplying a correct data signal to each of the pixels utilizing a demultiplexer since the digital drive system is driven with one frame being time-divided into a plurality of subframes. In conventional digital drive systems, the demultiplexer has been used to reduce the number of channels in the data drivers. The demultiplexer transfers a data signal to a plurality of data lines, wherein the data signal is supplied to an output end of each of the data drivers.

In conventional digital drive systems, wherein the number of the subframes in one frame is 15, and a first horizontal period is set to approximately 1.39 μs in driving a 3-inch WVGA panel (800×480RGB), the demultiplexer (for example, a 1:2 demultiplexer) transfers a data signal, which is supplied to one output line, to two data lines during one 1.39 μs horizontal period.

However, time is wasted during the 1.39 μs horizontal period to ensure a drive margin of two switches in the demultiplexer. Therefore, it is very difficult to supply the data signal to the two data lines sufficiently. For example, it is difficult to supply a data signal to pixels since a predetermined time is spent to ensure a drive margin of two switches during one horizontal period. Accordingly, the conventional digital drive system may be unable to display an image at a desired luminance.

### SUMMARY OF THE INVENTION

According to an exemplary embodiment of the present invention, a demultiplexer capable of improving a drive speed is provided.

According to another exemplary embodiment of the present invention, an organic light emitting display device using the demultiplexer is provided.

In an exemplary embodiment of the present disclosure, there is provided an organic light emitting display device, wherein the organic light emitting display device includes a scan driver for supplying a scan signal to scan lines during a frame time-divided into a plurality of subframes, a data driver coupled to output lines for supplying data signals on each of the output lines, demultiplexers coupled to the output lines for supplying the data signals to data lines, and pixels located at crossing regions of the data lines and the scan lines, wherein each of the demultiplexers includes a switch coupled between a corresponding one of the output lines and a first data line of the data lines, and wherein a second data line of the data lines is directly coupled with the corresponding one of the output lines.

In another exemplary embodiment of the present disclosure, there is provided a demultiplexer configured to receive a plurality of signals from a corresponding one of output lines and distribute the signals to i data lines, i being an integer greater than or equal to 2, wherein the demultiplexer includes a switch coupled between the corresponding one of the output lines and i-1 data lines of the i data lines, wherein a data line of the data lines other than the i-1 data lines is directly coupled to the corresponding one of the output lines.

In another exemplary embodiment of the present invention, there is provided a method of driving an organic light emitting display device, wherein the method includes providing data signals to demultiplexers through output lines, the data signals comprising a first data signal and a second data signal, distributing the first data signal to a first pixel having a first capacitor and a second pixel having a second capacitor during a first period of a scan period, storing voltage corresponding to the first data signal in the first and second capacitors, distributing the second data signal to the second pixel during a second period of the scan period, and storing voltage corresponding to the second data signal in the second capacitor.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram illustrating an organic light emitting display device according to one exemplary embodiment of the present invention.

FIG. 2 is a diagram illustrating one frame according to one exemplary embodiment of the present invention.

FIG. 3 is a diagram illustrating a demultiplexer and a pixel in accordance with the organic light emitting display device of FIG. 1.

FIG. 4 is a waveform diagram illustrating a method for driving the demultiplexer and the pixel of FIG. 3.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals refer to like elements throughout.

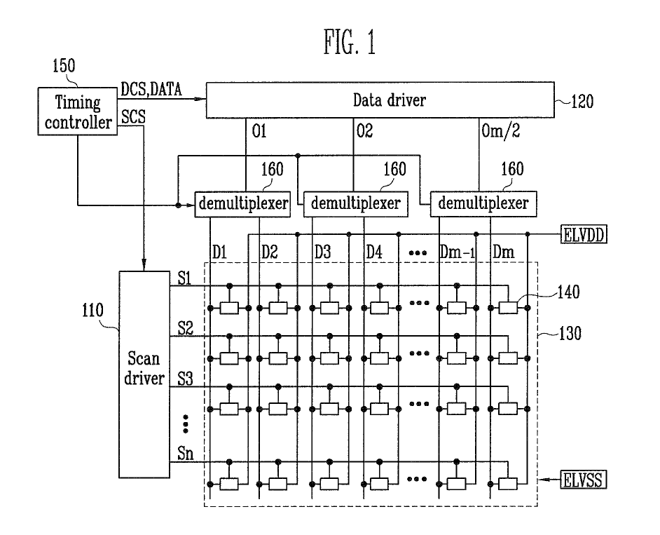

FIG. 1 is a block diagram illustrating an organic light emitting display device according to one exemplary embodiment of the present invention. A 1:2 demultiplexer 160 is shown in FIG. 1 for convenience of description, but the present invention is not limited thereto.

Referring to FIG. 1, the organic light emitting display device according to one exemplary embodiment of the present invention includes a scan driver 110, a data driver 120, a display unit 130, a timing controller 150, and demultiplexers 160. FIG. 1 shows a single scan driver 110 coupled to multiple scan lines S1 to Sn, a single data driver 120 coupled to multiple output lines O1 to Om/2, and a single timing controller 150 for convenience of description, but the present invention is not limited thereto.

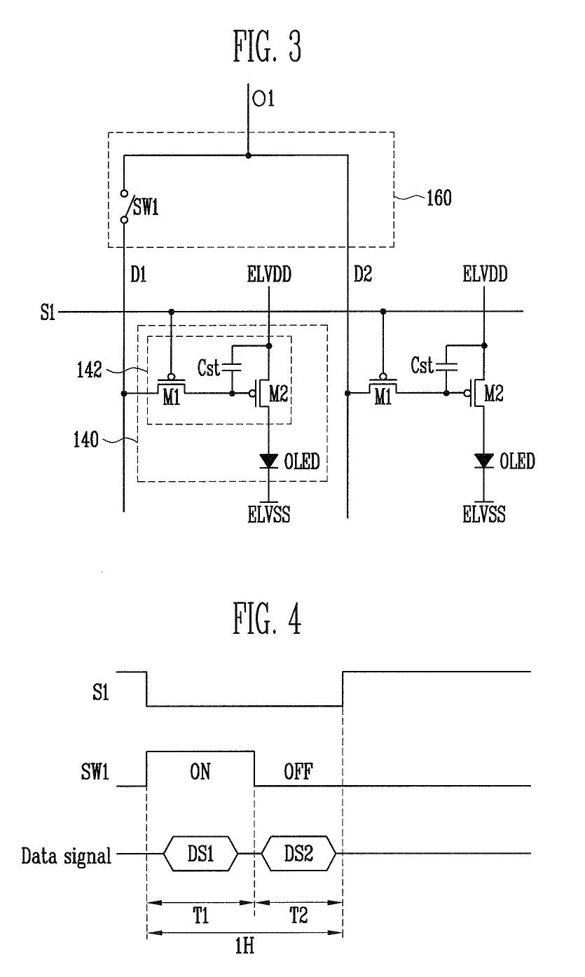

The timing controller 150 generates a data drive control signal DCS and a scan drive control signal SCS to correspond to synchronization signals supplied from the outside. The data drive control signal generated in the timing controller 150 is supplied to the data driver 120, and the scan drive control signal is supplied to the scan driver 110. The timing controller 150 rearranges data DATA supplied from the outside, and supplies the rearranged data to the data driver 120. Also, the timing controller 150 controls the turn on and turn off states of at least one switch (e.g., shown in FIG. 3) in each of the demultiplexers 160.

The data driver 120 sequentially supplies two data signals to each of the output lines O1 to Om/2 during a frame time-divided into a plurality of subframes. Here, the data signal includes a first data signal for controlling the pixels 140 to emit light and a second data signal for controlling the pixels 140 not to emit light.

The scan driver 110 supplies a scan signal to scan lines S1 to Sn during every horizontal period of each of the subframes. When the scan signal is supplied to the scan lines S1 to Sn, the pixels 140 are selected scan line by scan line. The selected pixels 140 receive a first data signal or a second data signal from the data lines D1 to Dm to turn on or turn off the pixels 140.

The display unit 130 receives a first power source ELVDD and a second power source ELVSS and supplies the received first power source and second power source to each of the pixels 140. Each of the pixels 140 receives a data signal until each of the pixels 140 is supplied with a scan signal. Such pixels 140 emit light or do not emit light in accordance with the received data signals.

The demultiplexers 160 are each coupled with one of the output lines O1 to Om/2 that are in turn coupled with one of the data drivers 120. Each of the demultiplexers 160 is coupled with two data lines D to supply a data signal, supplied through the output lines O1 to Om/2, to the two data lines D. In this embodiment, the number of the output lines O1 to Om/2 in the data driver 120 is decreased by half, and therefore it is possible to cut down the manufacturing cost.

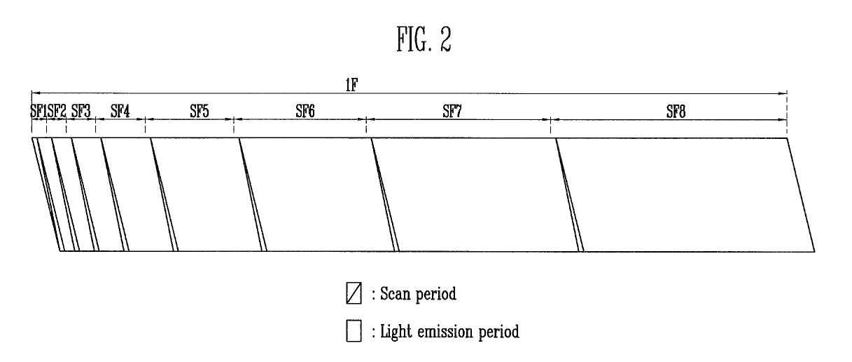

FIG. 2 is a diagram illustrating one frame according to an exemplary embodiment of the present invention.

Referring to FIG. 2, the one frame 1F according to an embodiment of the present invention is divided into a plurality of subframes SF1 to SF8 in a digital drive system. Each of the subframes SF1 to SF8 is divided into a scan period for supplying a scan signal and a light emission period wherein the pixels 140 that receive a first data signal during the scan period emit light.

The scan signal is supplied to the scan lines S1 to Sn during the scan period. Concurrently, the data signal, which is divided by the demultiplexer 160 and supplied (i.e., distributed) to the two data lines D, is supplied to each of the pixels 140. In other words, each of the pixels 140 receiving the scan signal receives a first data signal or a second data signal. One of ordinary skill would understand that the two data lines D is a system parameter, and may include more than two data lines D.

The pixels 140 emit light or do not emit light during the light emission period while the first data signal or second data signal is supplied to the pixels 140 during the scan period. In other words, each of the pixels 140 receiving the first data signal during the scan period is set to a light emission state during a corresponding subframe (e.g., during the light emission period corresponding to that subframe), and each of the pixels 140 receiving the second data signal is set to a non-light emission state during the corresponding subframe (e.g., during the light emission period corresponding to that subframe).

The light emission period is different in length in each of the subframes SF1 to SF8 to display desired gray levels. For example, when an image is displayed with 256 gray levels, one frame is divided into 8 subframes SF1 to SF8, as shown in FIG. 2. The light emission period is increased in each of the successive 8 subframes SF1 to SF8 according to the function 2ⁿ (n=0,1,2,3,4,5,6,7). In other words, each of the pixels 140 displays an image with a gray level by controlling the light emission of the pixels 140 in each of the subframes. The gray levels are displayed during one frame using the sum of the light emission periods of each of the subframes. The digital drive system may display an image with uniform luminance in spite of the non-uniformity of the drive transistors between the pixels 140 since it displays gray levels by controlling the on or off state of the pixels 140.

The frame as shown in FIG. 2 is represented by an exemplary embodiment of the present invention, but the present invention is not limited thereto. For example, a frame may be divided into 10 or more subframes, and a light emission period in each of the subframes may be set to different lengths by a designer. Each of the subframes may further include a reset period in addition to the scan period and the light emission period. The reset period is used to set the pixels 140 to a reset state.

FIG. 3 is a diagram illustrating a demultiplexer and a pixel in accordance with the organic light emitting display device of FIG. 1. The demultiplexer 160 coupled to a first output line O1 is shown in FIG. 3 for convenience of description.

Referring to FIG. 3, the demultiplexer 160 according to one exemplary embodiment of the present invention includes one switch SW1. The switch SW1 in the demultiplexer 160 is turned on during a first period T1 of the first horizontal period as shown in FIG. 4.

Each of the pixels 140 according to one exemplary embodiment of the present invention includes a pixel circuit 142 and an OLED.

The OLED emits light when an electrical current is supplied from the pixel circuit 142, and does not emit light when no electrical current is supplied from the pixel circuit 142.

The pixel circuit 142 supplies an electrical current to the OLED when a first data signal is supplied to the data lines, and does not supply the electrical current to the OLED of the pixel circuit 142 when a second data signal is supplied to the data lines. For this purpose, the pixel circuit 142 includes a first transistor M1, a second transistor M2, and a storage capacitor Cst.

A first electrode of the first transistor M1 is coupled to the data lines D, and a second electrode of the first transistor M1 is coupled to a gate electrode of the second transistor M2. A gate electrode of the first transistor M1 is coupled to the scan line S1. The first transistor M1 is turned on when a scan signal is supplied to the scan line S1. Once the data signal is supplied to the data lines D, voltage corresponding to the data signal is stored in the storage capacitor Cst. Here, the first electrode is chosen to be one of a source electrode or a drain electrode. If the first electrode is the drain electrode, the second electrode is the source electrode. If the first electrode is the source electrode, the second electrode is the drain electrode.

The gate electrode of the second transistor M2 is coupled to the second electrode of the first transistor M1. The first electrode of the second transistor M2 is coupled to the first power source ELVDD. The second electrode of the second transistor M2 is coupled to the OLED. The second transistor M2 controls the supply of an electrical current that flows from the first power source ELVDD to the second power source ELVSS via the OLED, when the second transistor M2 is turned on or turned off to correspond to the voltage charged in the storage capacitor Cst.

The storage capacitor Cst is coupled to a node between the first electrode of the first transistor M1 and the gate electrode of the second transistor M2. The storage capacitor Cst charges a voltage, that turns on the second transistor M2 when a first data signal is supplied to the data lines. Further, the storage capacitor Cst charges a voltage that turns off the second transistor M2 when a second data signal is supplied to the data lines.

The 1:2 demultiplexer 160 is shown in FIG. 3, but the present invention is not limited thereto. For example, when the demultiplexer 160 is coupled to i data lines D, where i is an integer greater than or equal to 2, i-1 data lines D are coupled with the output lines O via a switch, and the ith data line D is directly coupled to the output lines O without a switch.

FIG. 4 is a waveform diagram illustrating a method for driving the demultiplexer and the pixel of FIG. 3. It is assumed in FIG. 3 that the pixel 140 coupled to the first data line D1 is a first pixel, and the pixel 140 coupled to the second data line D2 is a second pixel for convenience of description.

Referring to FIG. 4, the first transistor M1 in each of the pixels 140 is turned on when a scan signal is supplied to a first scan line S1 during the horizontal period. The timing controller 150 supplies a control signal during a first period T1 of the horizontal period, turning on the first switch SW1 140 during the first period T1.

When the first switch SW1 is turned on, the data signal DS1 received on the first output line O1 is supplied to the first data line D1 and the second data line D2. Here, voltage corresponding to the data signal DS1 is stored in the storage capacitor Cst since the first transistors M1 of the first pixel and the second pixel are turned on by supplying a low scan signal to the scan line S1.

The first switch SW1 is turned off during a second period T2 of the horizontal period. When the first switch SW1 is turned off, the data signal DS2 is supplied to the storage capacitor Cst via the first transistor M1 of the second pixel during the second period T2 of the horizontal period. As a result, voltage corresponding to the data signal DS2 is stored in the storage capacitor Cst in the second pixel.

The voltage charged in the storage capacitor Cst of the first pixel is stored to a voltage corresponding to the data signal DS1. This is because the first switch SW1 is turned off during the second period T2 of the horizontal period. In addition, the second pixel may charge a voltage of the data signal DS2 regardless of the charged data signal DS1 during the first period of the horizontal period since the data signal DS2 is supplied to the storage capacitor Cst of the second pixel during the second period T2 of the horizontal period.

As a result, the first pixel and the second pixel emit light and/or do not emit light while being turned on and/or turned off to correspond to the data signals DS1 and DS2.

Referring still to FIG. 4, the first period T1 is set to be longer than the second period T2 in one embodiment of the present invention. This enables the data signal to be introduced into the data line at high speed since the supplied data signal DS2 is supplied to the data line D2 without passing through the switch SW1 during the second period T2 of the horizontal period. Therefore, the data signal is introduced stably even though the second period T2 is set to be shorter than the first period T1. In addition, it is possible to stably supply the data signal DS1, which is supplied via the switch SW1, to the first pixel by setting the first period T1 to be longer than the second period T2.

As described above, the demultiplexer 160 (in the case of a 1:2 demux) according to an exemplary embodiment of the present invention includes only one switch SW1. One data line D2 is directly coupled to one output line O1, and the other data line D1 is coupled to the output line O1 via the switch SW1. The demultiplexer 160 according to an exemplary embodiment of the present invention may reduce the time spent due to the presence of the drive margin of the switch SW1 since the demultiplexer 160 includes only one switch SW1. In addition, it is possible to ensure a sufficient drive margin in the digital drive system since a data signal is introduced at high speed into the data lines D2 directly coupled with the output line O1. Furthermore, the demultiplexer 160 according to one embodiment of the present invention may reduce or minimize the mounting area of the integrated circuit since the demultiplexer 160 includes only one switch SW1.

While the present invention has been described in connection with certain exemplary embodiments, one of ordinary skill in the art would understand that the invention is not limited to the disclosed embodiments, but, on the contrary, is intended to cover various modifications and equivalent arrangements included within the spirit and scope of the appended claims, and equivalents thereof.

1. An organic light emitting display device, comprising:
a scan driver for supplying a scan signal to scan lines during a frame time-divided into a plurality of subframes;
a data driver coupled to output lines for supplying data signals on each of the output lines;
demultiplexers coupled to the output lines for supplying the data signals to data lines; and
pixels located at crossing regions of the data lines and the scan lines,
wherein each of the demultiplexers includes a switch coupled between a corresponding one of the output lines and a first data line of the data lines, and
wherein a second data line of the data lines is directly coupled to the corresponding one of the output lines.

2. The organic light emitting display device according to claim 1, further comprising a timing controller for controlling turn-on and turn-off states of the switch in each of the demultiplexers.

3. The organic light emitting display device according to claim 2, wherein the timing controller is configured to turn on the switch during a first period of a horizontal period in which the scan signal is supplied to the scan lines, and is configured to turn off the switch during a second period of the horizontal period.

4. The organic light emitting display device according to claim 3, wherein the first period is longer than the second period.

5. The organic light emitting display device according to claim 3, wherein the data driver is configured to supply a first data signal of the data signals to the first data line during the first period, and is configured to supply a second data signal of the data signals to the second data line during the second period.

6. The organic light emitting display device according to claim 5, wherein the data driver is further configured to supply a first data signal of the data signals to the second data line during the first period.

7. A demultiplexer configured to receive a plurality of signals from a corresponding one of output lines and distribute the signals to i data lines, i being an integer greater or equal to 2, the demultiplexer comprising:
a switch coupled between the corresponding one of the output lines and i-1 data lines of the i data lines,
wherein a data line of the i data lines other than the i-1 data lines is directly coupled with the corresponding one of the output lines.

8. The demultiplexer of claim 7, wherein the switch is turned on during a first period of a horizontal period of a scan period, and the switch is turned off during a second period of the horizontal period.

9. The demultiplexer of claim 8, wherein the first period is longer than the second period.

10. (canceled)

11. (canceled)

12. A method of driving an organic light emitting display device, the method comprising;
providing data signals to demultiplexers through output lines, the data signals comprising a first data signal and a second data signal;
distributing the first data signal to a first pixel having a first capacitor and a second pixel having a second capacitor during a first period of a scan period;
storing voltage corresponding to the first data signal in the first and second capacitors;
distributing the second data signal to the second pixel during a second period of the scan period; and
storing voltage corresponding to the second data signal in the second capacitor.

13. The method according to claim 12, wherein the voltage corresponding to the second data signal is stored in the second capacitor while the voltage corresponding to the first data signal remains in the first capacitor.

14. The method according to claim 12, wherein the first period is longer than the second period.

15. The method according to claim 12, wherein the first data signal is distributed to the first pixel by turning on a switch located in one of the demultiplexers.

16. The method according to claim 15, wherein the switch is turned off during the second period of the horizontal period.
